(19) United States
(12) Patent Application Publication
(10) Pub. No.: US 2008/0022820 A1
(43) Pub. Date: Jan. 31, 2008

(54) Riving Knife System for Table Saw

(76) Inventors: Carl F. Merhar, Jackson, TN (US); Yung Ho Chang, Ta Li City (TW)

Correspondence Address: THE BLACK & DECKER CORPORATION, 701 EAST JOPPA ROAD, TW199, TOWSON, MD, 21286, US

(21) Appl. No.: 11/775,500

(22) Filed: Jul. 10, 2007

Related U.S. Application Data
(60) Provisional application No. 60/820,292, filed on Jul. 25, 2006.

(51) Int. Cl. B27B 5/00

(52) U.S. Cl. 83/102.1

(57) ABSTRACT

A table saw including a base assembly, a table assembly supported by the base assembly, a saw assembly connected to at least one of the base assembly and the table assembly, a riving knife assembly connected to the saw assembly, the riving knife assembly comprising a holder, a plate attached to the holder, a riving knife disposed between the holder and the plate, and a retainer disposed within the holder and contacting the riving knife. The retainer may be biased towards the riving knife.

### FIELD

This specification relates to table saws and more specifically to riving knife systems for table saws.

### BACKGROUND

It is well known in the table saw field to provide a riving knife assembly behind the table saw blade. Typically the riving knife assembly is difficult to remove from the table saw. Accordingly, it is an object of the invention to provide an enhanced riving knife assembly.

### SUMMARY

A table saw including a base assembly, a table assembly supported by the base assembly, a saw assembly connected to at least one of the base assembly and the table assembly, a riving knife assembly connected to the saw assembly, the riving knife assembly comprising a holder, a plate attached to the holder, a riving knife disposed between the holder and the plate, and a retainer disposed within the holder and contacting the riving knife. The retainer may be biased towards the riving knife.

Additional features and benefits of the present invention are described, and will be apparent from, the accompanying drawings and the detailed description below.

### BRIEF DESCRIPTION OF THE FIGURES

The accompanying drawings illustrate preferred embodiments according to the practical application of the principles thereof, and in which:

FIG. 1 is an exemplary table saw incorporating the invention.

FIG. 2 is an exploded perspective of an exemplary riving knife assembly according to the invention.

FIG. 3 illustrates the riving knife assembly of FIG. 2, where FIGS. 3A-3B are partial cross-sectional views along lines IIIA-IIIA and IIIB-IIIB of FIGS. 4A-4B, respectively.

FIG. 4 illustrates the riving knife assembly of FIG. 2, where FIGS. 4A-4B are partial cross-sectional views along lines IVA-IVA and IVB-IVB of FIGS. 3A-3B, respectively.

### DETAILED DESCRIPTION

The present invention will now be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

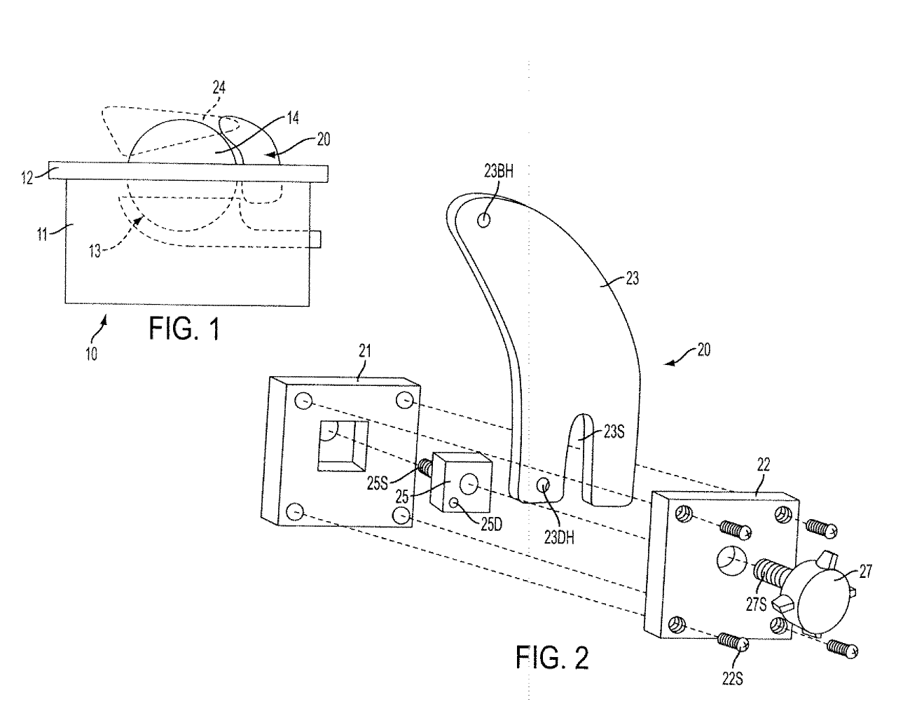

Referring to FIG. 1, a table saw 10 preferably includes a base assembly 11 that supports a table assembly 12. A saw assembly 13 is pivotably connected to the base assembly 11 and/or the table assembly 12. Examples of the saw assembly 13 can be found in U.S. Pat. Nos. 6,009,782 and 7,036,414, which are hereby fully incorporated herein by reference.

Saw assembly 13 may include a blade 14 driven by a motor (not shown).

Referring to FIGS. 1-4, a riving knife assembly 20 may be attached to the saw assembly 13. In particular, riving knife assembly 20 may include a holder 21 attached to the saw assembly 13, and a plate 22 attached to holder 21. Preferably, plate 22 is attached to holder 21 via screws 22S.

Riving knife assembly 20 preferably has a riving knife 23 with a curved blade edge which will be placed adjacent to blade 14. Riving knife 23 may be disposed between holder 21 and plate 22.

A retainer 25 may be disposed between holder 21. Such retainer 25 may have a screw 25S extending through holder 21 and captured by a washer 25W and nut 25N to prevent retainer 25 from being separated from holder 21. A spring 26 may be disposed between holder 21 and retainer 25 for biasing retainer 25 towards plate 22.

Retainer 25 may have a protrusion 25D that engages a depression, notch or hole 23DH in riving knife 23. Persons skilled in the art will recognize that protrusion 25D is effectively biased into such hole 23DH by spring 26.

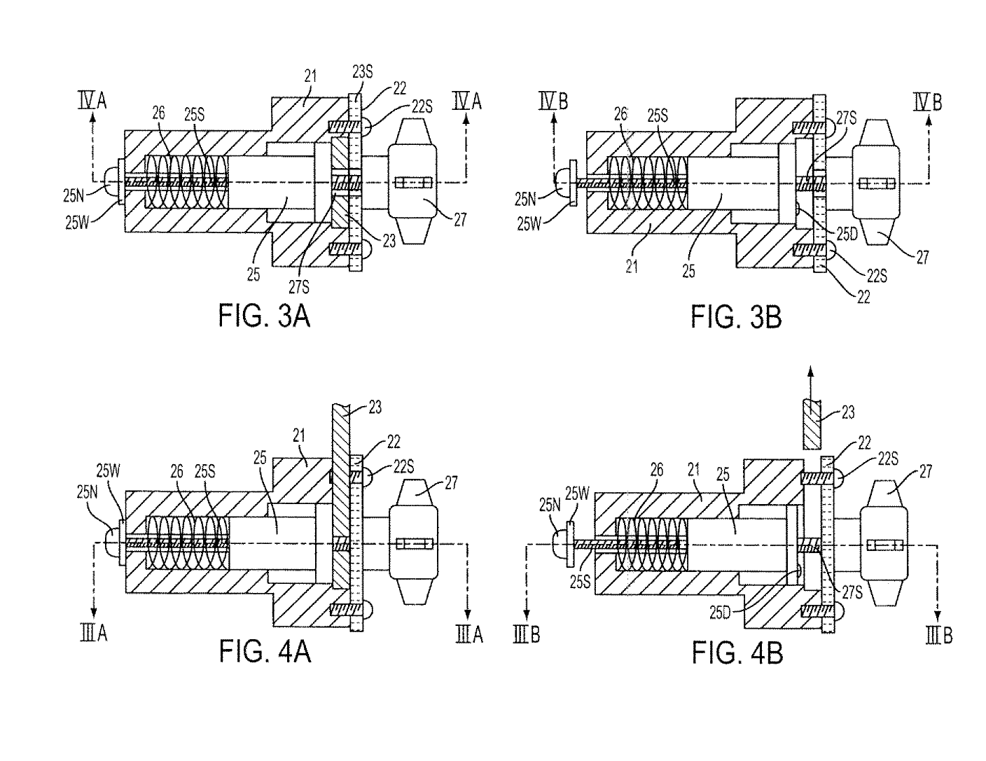

In order to lock the riving knife 23 within holder 21 and plate 22, it is preferable to provide a knob 27 that has a screw 27S extending through plate 22 and riving knife 23 and threadingly engages retainer 25. Persons skilled in the art will recognize that the same result will be achieved by providing an alternative screw on retainer 25 extending through plate 22 and riving knife 23 and threadingly engaging knob 27. With either arrangement, when the user rotates knob 27, riving knife will be lockingly sandwiched between retainer 25, plate 22 and knob 27, as shown in FIGS. 3A and 4A.

In order to remove riving knife 23 from holder 21 and plate 22, the user would loosen knob 27 and push knob 27 towards holder 21. This moves retainer 25 away from plate 22 and riving knife 23, disengaging protrusion 25D from hole 23DH, allowing the user to pull out riving knife 23 from holder 21 and plate 22, as shown in FIGS. 3B and 4B.

Persons skilled in the art will recognize that it is preferable to provide riving knife 23 with a slot 23S that allows screw 27S to extend therethrough and yet allow removal of riving knife 23 without having to remove screw 27S.

Persons skilled in the art will recognize that it may be advantageous to provide a blade guard assembly 24 that can be installed unto riving knife 23, as is well known in the art. Referring to FIG. 1, blade guard assembly 24 may have a thumbscrew (not shown) that can be inserted through hole 23BH on riving knife 23 for securing the blade guard assembly 24 unto riving knife 23.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A table saw comprising:
a base assembly;
a table assembly supported by the base assembly;
a saw assembly connected to at least one of the base assembly and the table assembly;
a riving knife assembly connected to the saw assembly, the riving knife assembly comprising a holder, a plate attached to the holder, a riving knife disposed between the holder and the plate, and a retainer disposed within the holder and contacting the riving knife, the retainer being biased towards the riving knife.

2. The table saw of claim 1, wherein the retainer has a protrusion engaging a notch in the riving knife.

3. The table saw of claim 1, further comprising a knob extending through the plate and riving knife and engaging the retainer.

4. The table saw of claim 3, wherein the knob threadingly engages the retainer.

5. The table saw of claim 1 wherein the retainer is captured within the holder.

6. A method for using a table saw, comprising the steps of:
providing the table saw with a base assembly, a table assembly supported by the base assembly, a saw assembly connected to at least one of the base assembly and the table assembly, a riving knife assembly connected to the saw assembly, the riving knife assembly comprising a holder, a plate attached to the holder, a riving knife disposed between the holder and the plate, and a retainer disposed within the holder and contacting the riving knife, the retainer being biased towards the riving knife, and a knob engaging the retainer, the knob extending through the plate and riving knife;
pushing the knob towards the riving knife; and
pulling the riving knife from the holder.

7. The method of claim 6, wherein the retainer has a protrusion engaging a notch in the riving knife.

8. The method of claim 6, wherein the knob threadingly engages the retainer.
